(19) United States
(12) Patent Application Publication
(10) Pub. No.: US 2024/0027200 A1
(43) Pub. Date: Jan. 25, 2024

(54) VEHICLE MANAGEMENT SYSTEM, VEHICLE, AND STORAGE MEDIUM

(71) Applicant: TOYOTA JIDOSHA KABUSHIKI KAISHA, Toyota-shi (JP)

(72) Inventors: Taizo MASUDA, Yokohama-shi (JP); Kiyoto SASAKI, Susono-shi (JP); Daisuke KAKUMA, Toyota-shi (JP); Hiroyoshi MASUI, Susono-shi (JP); Akihiro YAMAGUCHI, Toyota-shi (JP); Sokfan YEE, Toyota-shi (JP); Yuki NISHIKAWA, Numazu-shi (JP)

(73) Assignee: TOYOTA JIDOSHA KABUSHIKI KAISHA, Toyota-shi (JP)

(21) Appl. No.: 18/324,537

(22) Filed: May 26, 2023

(30) Foreign Application Priority Data
Jul. 25, 2022 (JP) 2022-118048

(51) Int. Cl. G01C 21/34; B60W 60/00; B60W 50/14; B60W 50/10; G01C 21/36

(52) U.S. Cl. CPC G01C 21/3407; B60W 60/00253; B60W 50/14; B60W 50/10; G01C 21/3679; B60W 30/06

(57) ABSTRACT

A vehicle management system includes one or more storage devices that store entrance and exit information indicating a correspondence relationship between a location of an entrance and a location of an exit for each area, and one or more processors. The processors determine whether an alighting position at which a user of the vehicle gets off the vehicle is the location of the entrance, based on the entrance and exit information, and set a destination of the vehicle so that the vehicle moves to the location of the exit corresponding to the entrance, when the alighting position of the user is the location of the entrance.

### CROSS-REFERENCE TO RELATED APPLICATION

This application claims priority to Japanese Patent Application No. 2022-118048 filed on Jul. 25, 2022 incorporated herein by reference in its entirety.

### BACKGROUND

### 1. Technical Field

The present disclosure relates to technology for managing the movement of a vehicle.

### 2. Description of Related Art

Japanese Unexamined Patent Application Publication No. 2020-134953 (JP 2020-134953 A) discloses an information processing device that appropriately provides information on various facilities that provide products and services that match user attributes such as user needs, tastes, and characteristics, in response to user requests. The information processing device outputs to the user information on facilities that match the user attributes and have not been visited by the user. The user can increase chances of visiting facilities that are likely to match his/her requests.

### SUMMARY

Suppose a user of a vehicle visits an area in which a location of an entrance and a location of an exit differ from each other by vehicle. After parking the vehicle at the entrance and visiting the area, the user leaves the area through the exit located at a location different from the location where the vehicle is parked. Therefore, in order to get on the vehicle again, the user has to return to the entrance on foot, using public transportation, or using a taxi, for example.

An object of the present disclosure is to provide technology that can reduce the time and effort needed for the user who visits the area in which the location of the entrance and the location of the exit differ from each other by vehicle, thereby improving convenience.

A first aspect relates to a vehicle management system for managing a vehicle.
A vehicle management system includes
one or more storage devices that store entrance and exit information indicating a correspondence relationship between a location of an entrance and a location of an exit for each area, and
one or more processors.
The processors
determine whether an alighting position at which a user of the vehicle gets off the vehicle is the location of the entrance, based on the entrance and exit information, and
set a destination of the vehicle such that the vehicle moves to the location of the exit corresponding to the entrance, when the alighting position of the user is the location of the entrance.

A second aspect relates to a vehicle that is able to be driven autonomously.
The vehicle includes
one or more storage devices that store entrance and exit information indicating a correspondence relationship between one or more locations of entrances and a location of an exit for each area, and
one or more processors.
The processors
determine whether an alighting position at which a user of the vehicle gets off the vehicle is a location of an entrance, based on the entrance and exit information, and
set a destination of the vehicle such that the vehicle moves to the location of the exit corresponding to the entrance, when the alighting position is the location of the entrance.

A third aspect relates to a storage medium storing a vehicle management program for managing a vehicle.
The vehicle management program causes a computer to execute:
acquiring entrance and exit information indicating a correspondence relationship between one or more locations of entrances and a location of an exit for each area;
determining whether an alighting position at which a user of the vehicle gets off the vehicle is a location of an entrance, based on the entrance and exit information; and
setting a destination of the vehicle such that the vehicle moves to the location of the exit corresponding to the entrance, when the alighting position is the location of the entrance.

In accordance with the technology of the present disclosure, it is possible to reduce the time and effort needed for the user who visits the area in which the location of the entrance and the location of the exit differ from each other by vehicle, thereby improving convenience.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of an area in which a location of an entrance and a location of an exit differ from each other according to the present embodiment;

FIG. 2 is a diagram illustrating an overview of an area in which locations of entrances and a location of an exit differ from each other according to the present embodiment;

FIG. 3 is a block diagram showing a configuration example of a vehicle management system according to the present embodiment;

FIG. 4 is a block diagram showing a configuration example of a vehicle, a management server, and a user terminal according to the present embodiment;

FIG. 5 is a flowchart showing an example of a process executed by the vehicle management system according to the present embodiment;

FIG. 6 is a table illustrating an example of entrance and exit information according to the present embodiment;

FIG. 7 is a diagram illustrating an example of an exit of an area in which a location of an entrance and a location of the exit differ from each other according to the present embodiment;

FIG. 8 is a flowchart showing an example of a process executed by the vehicle management system according to a second embodiment; and

FIG. 9 is a flowchart showing an example of a process executed by the vehicle management system according to a third embodiment.

### DETAILED DESCRIPTION OF EMBODIMENTS

Embodiments of the present disclosure will be described with reference to the accompanying drawings.

### 1. Overview

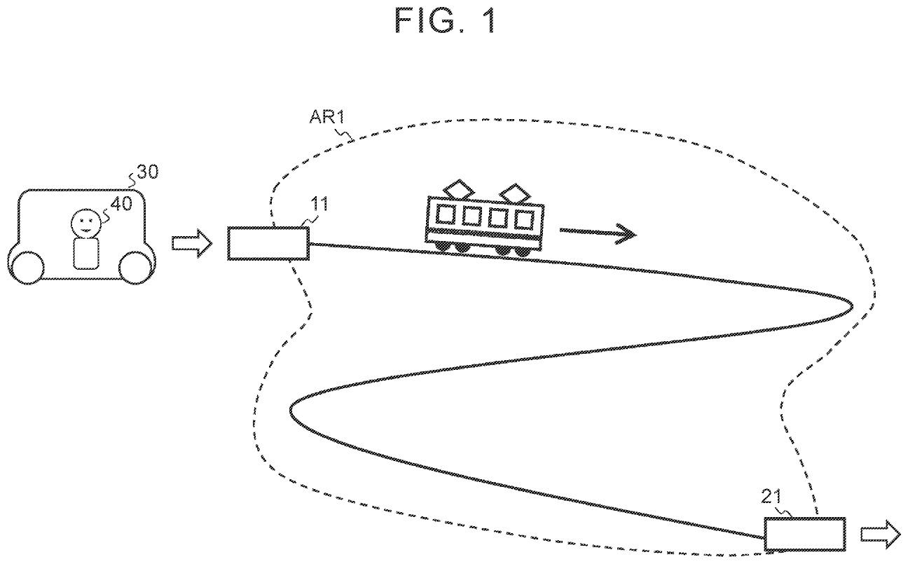

Suppose a user of a vehicle visits an area in which a location of an entrance and a location of an exit differ from each other by vehicle. FIG. 1 shows a sightseeing area AR1 as an example of an area AR in which a location of an entrance and a location of an exit differ from each other. The sightseeing area AR1 is an area in which a user 40 of a vehicle 30 can go sightseeing by riding a sightseeing train. The entrance 11 of the sightseeing area AR1 is a departure station for boarding the sightseeing train, and the exit 21 of the sightseeing area AR1 is an arrival station of the sightseeing train. The user 40 who has come to the entrance 11 by a vehicle 30 parks the vehicle 30 in a parking lot or the like at the entrance 11 and gets on the sightseeing train. The sightseeing train with the user 40 on board runs toward the exit 21, and the user 40 gets off the train at the exit 21 and leaves the sightseeing area AR1.

In other words, the user 40 who has visited the sightseeing area AR1 has moved to the exit 21 when sightseeing is finished. In contrast, the vehicle 30 remains parked in the parking lot at the entrance 11. Therefore, the user 40 who has enjoyed sightseeing must return to the location of the entrance 11 on foot or by using public transportation or a taxi in order to get on the vehicle 30 again.

In this way, when the user 40 visits the area AR in which the location of the entrance and the location of the exit differ from each other by the vehicle 30, the time and effort needed for the user 40 to move after the user 40 has left the area AR may increase. Therefore, in the vehicle management system according to the present embodiment, when the user 40 visits an area AR in which the location of the entrance and the location of the exit are different from each other, the vehicle 30 is managed so that the vehicle 30 moves to the location of the exit of the area AR after the user 40 has got off the vehicle 30 at the location of the entrance of the area AR. As a result, it is possible to reduce the time and effort needed for the user 40 to move, thereby improving convenience.

Examples of the area AR in which the location of the entrance and the location of the exit differ from each other include highways, mountain climbing trails, areas for rafting and paragliding, shopping malls, and the like in addition to areas such as the sightseeing area AR1 in which a train system is operated. The area AR may be a facility including one or more buildings or structures, or may be an outdoor area of a certain range.

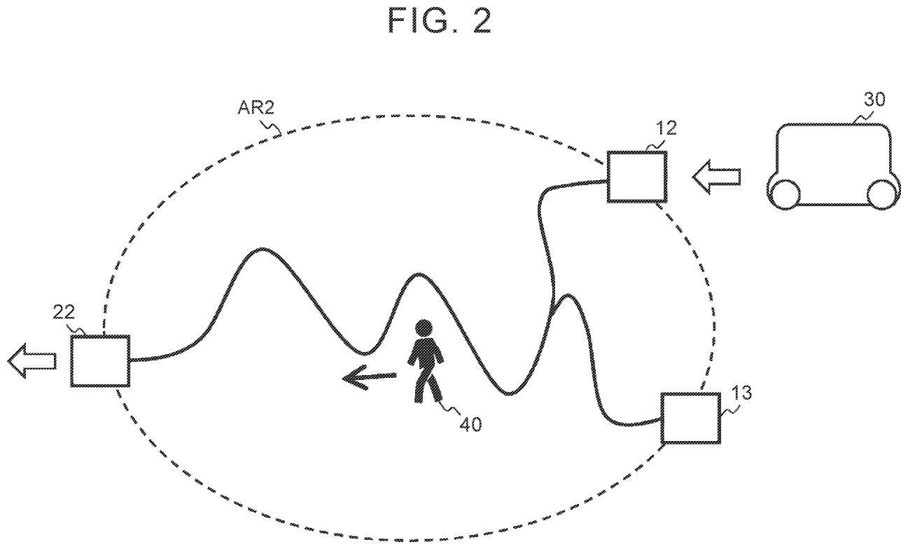

Also, the area AR may be an area having a plurality of entrances. FIG. 2 shows an area AR2 as another example of the area AR. The area AR2 is an area in which the user 40 can stroll along a walking trail. To avoid congestion, the walking trail in the area AR2 is set to one-way traffic. The area AR2 has two entrances, that is an entrance 12 and an entrance 13, and the user 40 can enter the area AR2 from the entrance 12 and stroll, or enter the area AR2 from the entrance 13 and stroll. However, the exit 22 is a single exit, and the user 40 who has entered the area AR2 from either entrance exits the area AR2 from the exit 22 through the one-way walking trail. Since the area AR has one exit as described above, the vehicle management system can set the destination of the vehicle 30 to the exit of the area AR so that the vehicle 30 moves to the exit after the user 40 gets off the vehicle 30. As a result, it is possible to reduce the time and effort needed for the user 40 to move, thereby improving convenience.

### 2. Configuration

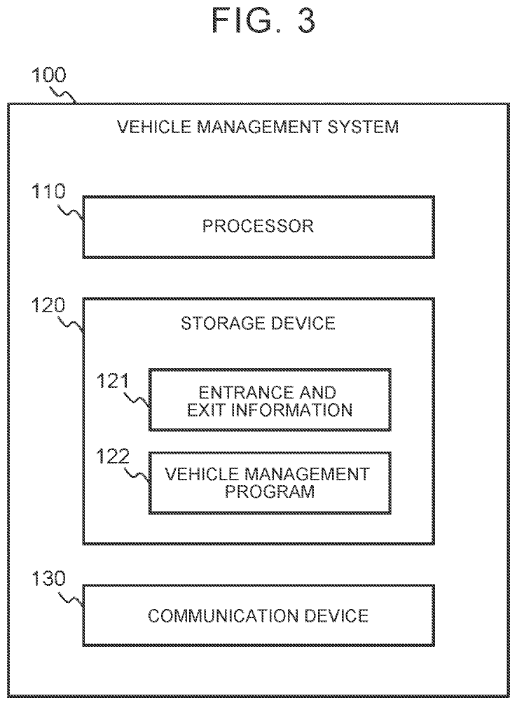

FIG. 3 is a block diagram showing a configuration example of a vehicle management system 100 according to the present embodiment. The vehicle management system 100 includes one or more processors 110 (hereinafter simply referred to as a processor 110), one or more storage devices 120 (hereinafter simply referred to as a storage device 120), and one or more communication devices 130 (hereinafter simply referred to as a communication device 130).

The storage device 120 stores entrance and exit information 121 and a vehicle management program 122. The entrance and exit information 121 is information indicating the correspondence relationship between the location of the entrance and the location of the exit for each area. The vehicle management program 122 is a computer program for the vehicle management system 100 to manage the vehicle 30. The processor 110 executes the vehicle management program 122 to manage the vehicle 30 by the vehicle management system 100 so that the vehicle 30 moves to the exit. The vehicle management program 122 may be recorded on a computer-readable recording medium (storage medium).

The communication device 130 is a device that communicates with the outside of the vehicle management system 100. The communication device 130 can, for example, communicate with a user terminal. The user terminal is a terminal such as a smart phone owned by the user 40.

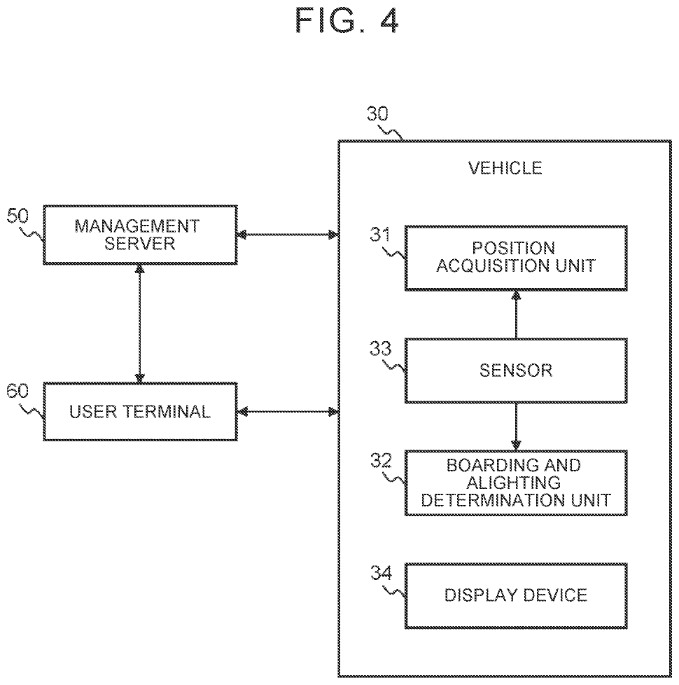

FIG. 4 is a diagram showing the vehicle 30, a management server 50, and a user terminal 60 as components related to the vehicle management system 100.

The vehicle management system 100 may be a system installed in the vehicle 30. The vehicle 30 is a vehicle used by the user 40. The vehicle 30 may be an autonomous driving vehicle capable of autonomous driving, or a remotely operated vehicle capable of being remotely operated by a remote operator. Alternatively, the vehicle 30 may be a vehicle capable of being both manually operated by a driver and autonomously driven or remotely operated.

Also, the vehicle 30 may be a vehicle managed by the management server 50. When the vehicle 30 is an autonomous driving vehicle, management of the vehicle 30 by the management server 50 includes, for example, setting a destination for the vehicle 30 and transmitting the set destination to the vehicle 30. Alternatively, management of the vehicle 30 by the management server 50 may include setting the travel route of the vehicle 30, acquiring position information of the vehicle 30 and information about the surroundings of the vehicle 30, controlling autonomous driving of the vehicle 30 based on the acquired information, and so forth. When the vehicle 30 is a remotely operated vehicle, management of the vehicle 30 by the management server 50 includes, for example, assigning a remote operator who remotely operates the vehicle 30 and connecting the vehicle 30 and the remote operator. When the vehicle 30 is managed by the management server 50, the vehicle management system 100 may be a system included in the management server 50.

Alternatively, the vehicle management system 100 may be a system that includes both the vehicle 30 and the management server 50. In this case, the processor 110 may be installed in the vehicle 30, may be installed in the management server 50, or may be distributed and installed in the vehicle 30 and the management server 50. Here, the processor installed in the vehicle 30 may include a processor of an electronic control unit (ECU). Further, the storage device 120 may be installed in the vehicle 30, may be installed in the management server 50, or may be distributed and installed in the vehicle 30 and the management server 50.

Although not shown, the vehicle 30 and the management server 50 are provided with communication devices and can communicate with each other. The communication device 130 may be a communication device provided in the vehicle 30, may be a communication device provided in the management server 50, or may include both. Either or both of the vehicle 30 and the management server 50 may be able to communicate with the user terminal 60 owned by the user 40 via the communication device.

In this case, the user terminal 60 can acquire information input by the user 40, position information of the user 40, and the like, and transmit the information to the vehicle 30 or the management server 50. The user terminal 60 can also be used as a display device that receives the information transmitted from the vehicle 30 or the management server 50 and displays the received information to the user 40.

The vehicle 30 also includes a position acquisition unit 31. The position acquisition unit 31 is a functional unit that acquires the current position of the vehicle 30. The position acquisition unit 31 is implemented by an ECU installed in the vehicle 30 acquiring information from a position sensor such as a global positioning system (GPS) sensor installed in the vehicle 30.

The vehicle 30 also includes a boarding and alighting determination unit 32. The boarding and alighting determination unit 32 is a functional unit that determines that the user 40 has got on the vehicle 30 or the user 40 has got off the vehicle 30. The boarding and alighting determination unit 32 is implemented by the ECU of the vehicle 30 acquiring information from a sensor installed in the vehicle 30. For example, it may be determined that the user 40 has got on the vehicle 30 or got off the vehicle 30 by acquiring information from an open/close sensor that detects opening/closing of the door. Alternatively, it may be determined that the user 40 has got on the vehicle 30 or got off the vehicle 30 by information acquired from a weight sensor installed in a seat of the vehicle 30. Alternatively, it may be determined that the user 40 has got on the vehicle 30 or got off the vehicle 30 by analyzing a camera image obtained by an in-vehicle camera capturing the inside of the vehicle 30.

The sensor 33 is a sensor installed in the vehicle 30. Examples of the sensor 33 include recognition sensors such as a camera, a weight sensor, and a door open/close sensor, position sensors such as a GPS sensor, and internal sensors for acquiring information inside the vehicle 30 such as speed and acceleration. Information obtained from the position acquisition unit 31, the boarding and alighting determination unit 32, and the sensor 33 is acquired by the processor 110 through an in-vehicle network or a wireless network.

The vehicle 30 may also include the display device 34. The display device 34 is a terminal that displays information to the user 40 or an occupant of the vehicle 30 other than the user 40. For example, the display device 34 can display information about the destination of the vehicle 30 to the user 40. Further, the display device 34 may be a device that receives input from the occupant of the vehicle 30 with respect to the displayed information as well as a device that displays information.

### 3. Process Example (First Embodiment)

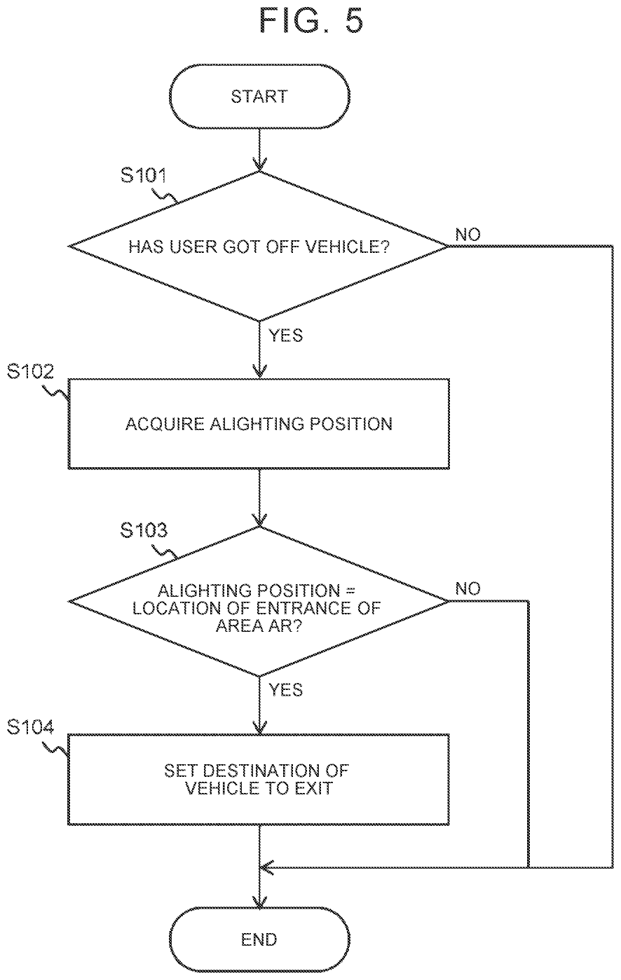

FIG. 5 is a flowchart showing an example of a process executed by the vehicle management system 100 according to a first embodiment. The process shown in the flowchart of FIG. 5 is repeatedly executed at a predetermined control cycle. The process of each step in the flowchart of FIG. 5 is realized as the processor 110 executes the vehicle management program 122. Note that when the processor 110 is a processor distributed and installed in the vehicle 30 and the management server 50, the process of each step may be distributed and executed by the processor of the vehicle 30 and the processor of the management server 50.

In step S101, the processor 110 determines whether the user 40 has got off the vehicle 30. When the user 40 has got off the vehicle 30 (step S101; Yes), the process proceeds to step S102. When the user 40 continues to be in the vehicle 30, or when the user has not yet got on the vehicle 30 (step S101; No), the process of the present cycle ends.

The processor 110 can make the determination in step S101 based on information acquired from the sensor 33 of the vehicle 30. For example, the processor 110 can determine whether the user 40 has got off the vehicle based on information on opening and closing of the door acquired by the open/close sensor and information acquired by the weight sensor of the seat of the vehicle 30 or the camera. Alternatively, in step S101, the processor 110 may acquire the result of the determination made by the boarding and alighting determination unit 32 of the vehicle 30.

In step S102, the processor 110 acquires the position of the vehicle 30 when the user 40 has got off the vehicle 30 as an alighting position of the user 40. The alighting position may be acquired from the position sensor of the vehicle 30 or may be acquired from the position acquisition unit 31, for example. After the alighting position is acquired, the process proceeds to step S103.

In step S103, the processor 110 determines whether the alighting position is the location of the entrance of the area AR. When the alighting position is the location of the entrance (step S103; Yes), the process proceeds to step S104. When the alighting position is not the location of the entrance (step S103; No), the process of the present cycle ends.

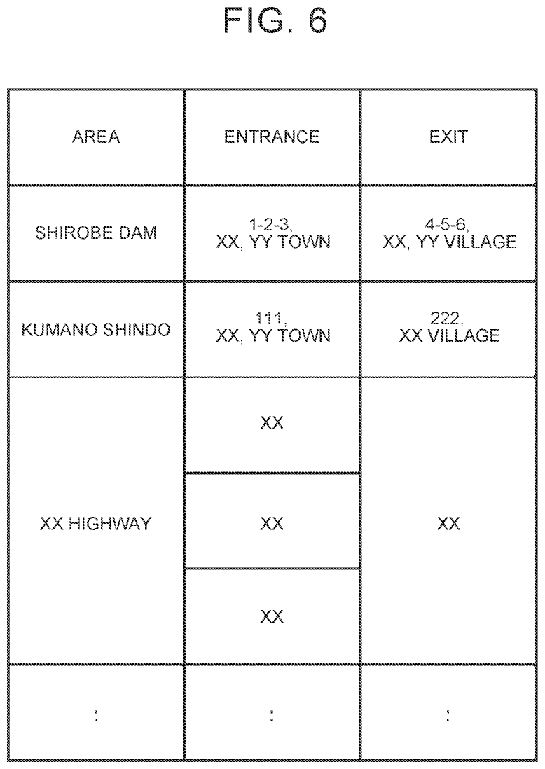

The processor 110 can determine whether the alighting position is the location of the entrance of the area AR, based on the entrance and exit information 121. FIG. 6 shows an example of the entrance and exit information 121. The entrance and exit information 121 is indicated associating the location of the entrance with the location of the exit for each of one or more areas AR. In other words, the entrance and exit information 121 indicates the correspondence relationship between the location of the entrance and the location of the exit for each area AR. The processor 110 refers to the entrance and exit information 121 and determines whether the alighting position acquired in step S102 matches the location of the entrance of any area AR. The entrance and exit information 121 may further include information on a parking lot and a boarding/alighting place around the entrance, and information on a parking lot and a boarding/alighting place around the exit. Then, for example, when the alighting position of the user 40 matches a location of a parking lot near the entrance as well as when the alighting position of the user 40 completely matches the location of the entrance, the processor 110 may determine that the alighting position is the location of the entrance.

In step S104, the processor 110 sets the destination of the vehicle 30 to the location of the exit. Setting the destination to the location of the exit means that the processor controlling the movement of the vehicle 30 or the remote operator is in a state capable of recognizing that the destination of the vehicle 30 is the location of the exit. For example, in step S104, information on the destination may be stored in the storage device 120 so that the information can be referenced by a processor other than the processor 110. Alternatively, for example, when the vehicle 30 is a remotely operated vehicle, the information on the destination may be transmitted to the remote operator so that the remote operator can operate the vehicle 30 to move the vehicle 30 to the location of the exit. Further, when the vehicle 30 is an autonomous driving vehicle, the information on the destination may be transmitted to the ECU of the vehicle 30.

When the vehicle 30 is an autonomous driving vehicle, after the destination is set, the vehicle 30 is controlled directly by the processor 110 or indirectly by transmitting necessary information to the ECU, and thus the vehicle 30 moves toward the destination.

The location of the exit that is to be the destination of the vehicle 30 is the location of the exit corresponding to the entrance determined to match the alighting position in step S103. The processor 110 can set the destination by referring to the entrance and exit information 121 and thus acquiring information on the location of the exit. The destination may be set not at the exit itself. The destination may be set at the parking lot or the boarding/alighting place around the exit.

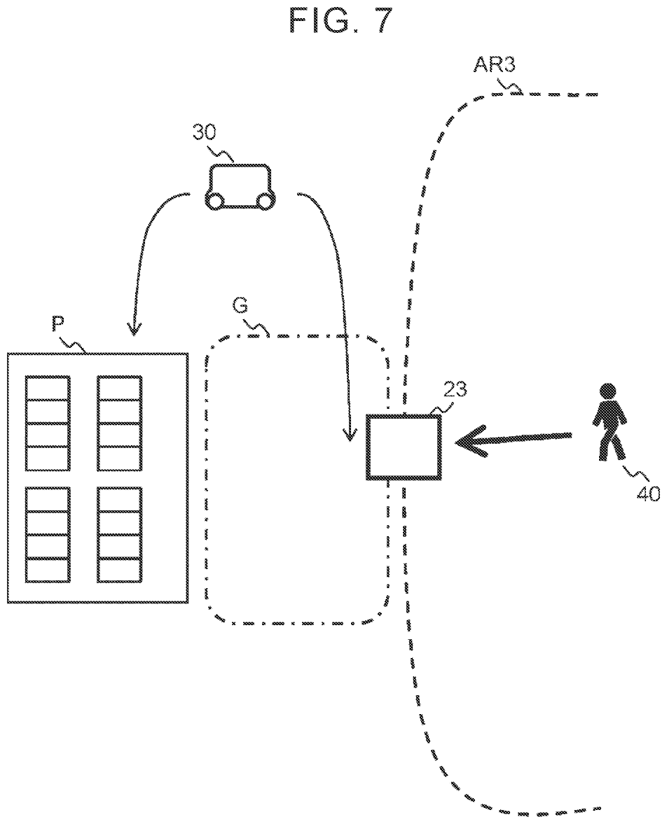

FIG. 7 is a diagram showing the surroundings of an exit 23 of an area AR3 as an example of the area AR. Around the exit 23, there are a boarding/alighting place G for the user 40 to get on/off the vehicle 30, and a parking lot P. The processor 110 may set the destination directly in front of the exit 23, may set the boarding/alighting place G as the destination, or may set the parking lot P as the destination. Alternatively, the processor 110 may set a destination including a temporary standby point so that the vehicle 30 can head to the boarding/alighting place G after standing by in the parking lot P. When the destination is set, the process of the present cycle ends.

### 4. Second Embodiment

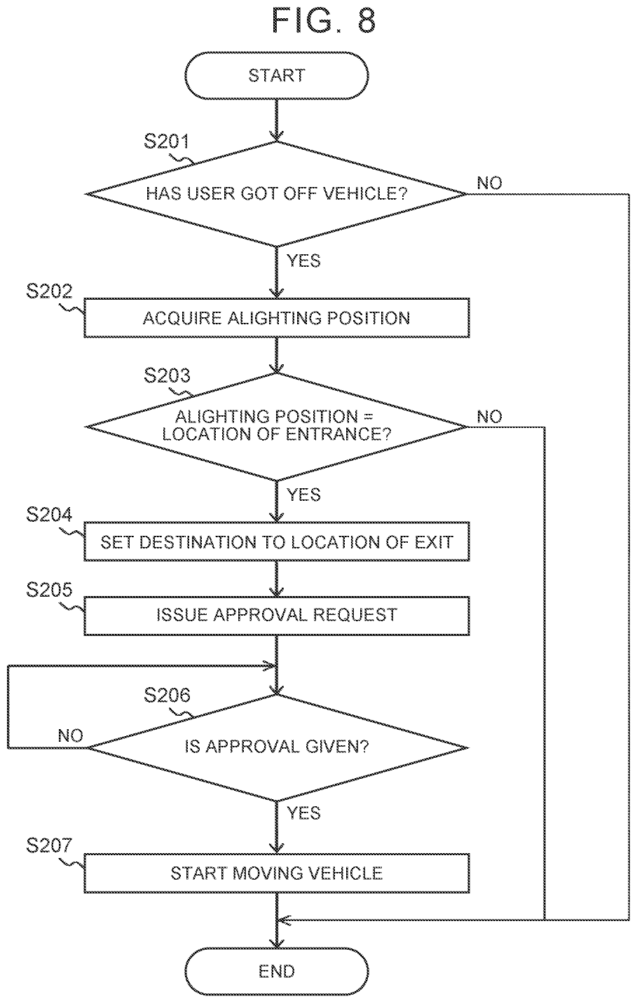

FIG. 8 is a flowchart showing an example of a process executed by the vehicle management system 100 according to a second embodiment. The process shown in the flowchart of FIG. 8 is repeatedly executed at a predetermined control cycle. The process of each step in the flowchart of FIG. 8 is realized as the processor 110 executes the vehicle management program 122. Note that when the processor 110 is a processor distributed and installed in the vehicle 30 and the management server 50, the process of each step may be distributed and executed by the processor of the vehicle 30 and the processor of the management server 50.

The process in steps S201 to S204 in FIG. 8 is the same as the process in steps S101 to S104 in FIG. 5. However, the destination is only set in step S204, and the movement of the vehicle 30 is not started. After setting the destination, the process proceeds to step S205.

In step S205, the processor 110 issues an approval request toward the user 40. The approval request issued here is a request for approval of the user 40 for setting the destination of the vehicle 30 to the location of the exit. The processor 110 may transmit the approval request to the user terminal 60 and display a message requesting for approval to the user 40, or request for approval by displaying a message to the user 40 on the display device 34. When the approval request is issued, the process proceeds to step S206.

In step S206, the processor 110 determines whether approval is given by the user 40 with respect to the approval request. When approval is given (step S206; Yes), the process proceeds to step S207. When approval is not given (step S206; No), the process returns to step S206 again. When the user 40 gives approval, the user 40 inputs information indicating the approval to a device such as the user terminal 60 or the display device 34 that can receive the input from the user 40. The processor 110 can determine the presence or absence of approval of the user 40 by acquiring information input by the user 40 from the devices.

In step S207, the processor 110 causes the vehicle 30 to start moving. When the vehicle 30 is an autonomous driving vehicle, information permitting start of movement is transmitted from the processor 110 to the ECU of the vehicle. Alternatively, direct or indirect control of the vehicle 30 by the processor 110 starts so that the vehicle 30 travels toward the destination. When the vehicle 30 is a remotely operated vehicle, the processor 110 transmits an instruction to the remote operator to start moving the vehicle 30. When the movement of the vehicle 30 is started, the process of the present cycle ends.

The pace at which the user 40 moves from the entrance to the exit of the area AR may vary depending on the user 40. In particular, when the area AR is a sightseeing area where people move by walking, for example, the difference between the users 40 becomes large. Therefore, the user 40 who wants to move slowly in the area AR may feel rushed when the vehicle 30 starts moving toward the exit immediately after getting off at the entrance. In the second embodiment, the movement of the vehicle 30 is started upon approval given by the user 40. As a result, the user 40 can start moving the vehicle 30 at his/her own pace, and can manage the vehicle 30 in a friendly manner to the user 40. In addition, by causing the vehicle 30 to start moving after confirming the approval of the user it is possible to suppress the user 40 from accidentally returning to the entrance without noticing that the vehicle 30 has moved toward the exit, which makes the system more convenient.

### 5. Third Embodiment

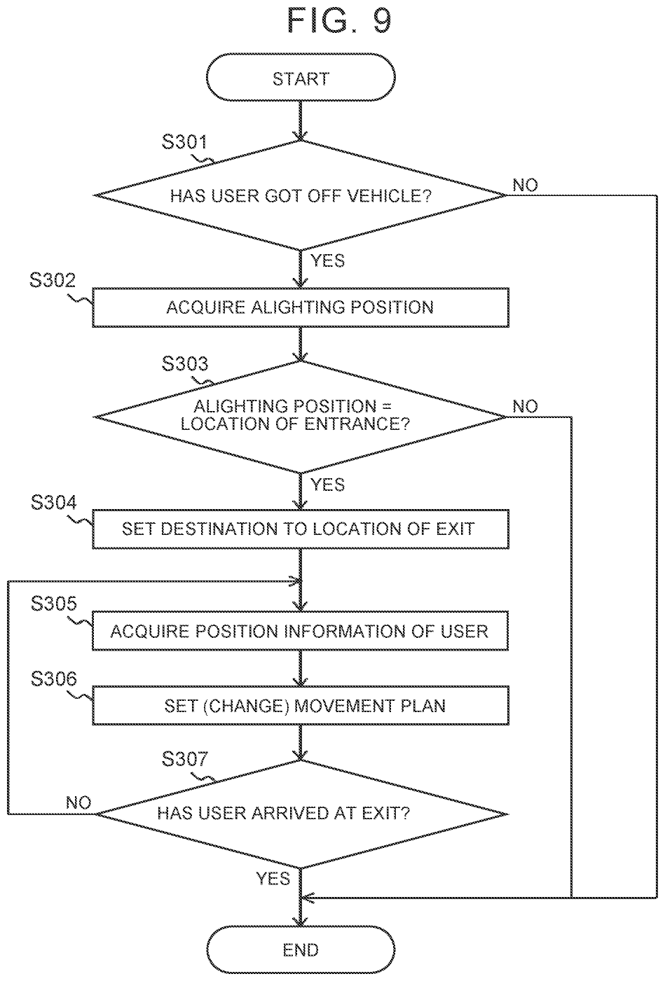

FIG. 9 is a flowchart showing an example of a process executed by the vehicle management system 100 according to a third embodiment. The process shown in the flowchart of FIG. 9 is repeatedly executed at a predetermined control cycle. The process of each step in the flowchart of FIG. 9 is realized as the processor 110 executes the vehicle management program 122. Note that when the processor 110 is a processor distributed and installed in the vehicle 30 and the management server 50, the process of each step may be distributed and executed by the processor of the vehicle 30 and the processor of the management server 50.

The process from step S301 to step S304 in the flowchart of FIG. 9 is the same as the process from step S101 to step S104 in FIG. 5. However, when the destination is set in step S304, the process proceeds to step S305.

In step S305, the processor 110 acquires position information about the current position of the user 40. Here, the current position of the user terminal 60 is regarded as the current position of the user 40. The user terminal 60 acquires its own position information using GPS or the like. The position information of the user terminal 60 is transmitted from the user terminal 60 to the vehicle management system 100. The processor 110 acquires the position information of the user terminal 60 as the position information of the user 40. When the position information is acquired, the process proceeds to step S306.

In step S306, the processor 110 sets a movement plan of the vehicle 30. The movement plan set here is a plan for moving the vehicle 30 to the destination, and the plan includes at least one of the target arrival time of the vehicle 30 at the destination, the timing at which the vehicle 30 starts moving toward the destination, and the moving speed of the vehicle 30. The movement plan is decided in accordance with the position information of the user 40 acquired in step S305. When the movement plan is already set in step S306, the movement plan is changed in accordance with the position information of the user 40. After the movement plan is set, the process proceeds to step S307.

In step S307, the processor 110 determines whether the user 40 has arrived at the exit of the area AR based on the position information of the user 40. When the user 40 has arrived at the exit (step S307; Yes), the process of the present cycle ends. When the user 40 has not arrived at the exit (step S307; No), the process returns to step S305.

The time it takes the user 40 to enter the area AR from the entrance and exit from the exit may vary depending on the user 40. Therefore, when the timing for moving the vehicle 30 to the exit is uniformly decided regardless of the user 40, the waiting time for the vehicle 30 may be long from the time of arrival of the vehicle 30 at the destination to the time when the user 40 exits from the exit and gets on the vehicle 30. Then, for example, when the space where the vehicle 30 waits for the user 40, such as the boarding/alighting place G shown in FIG. 7, is limited, the space may be crowded with a plurality of vehicles 30 waiting for the users 40 and the traffic flow may be disrupted. Conversely, when the vehicle 30 arrives too late at the exit, there is a possibility that the vehicle 30 cannot make it in time for the user 40 to come out, which reduces the convenience for the user 40.

Therefore, in the third embodiment, the processor 110 acquires the position information of the user 40 until the user 40 leaves the area AR. Then, a movement plan is decided in accordance with the position information of the user 40 so that the vehicle 30 can head to the exit of the area AR at an appropriate timing. As a result, it is possible to reduce the reduction of convenience for the user 40 and the influence on the traffic flow of the vehicle 30.

The process of step S305 and S306 in the flowchart of FIG. 9 may be executed before the vehicle 30 starts moving, or may be executed after the vehicle 30 has started moving. When executed before the vehicle 30 starts moving, the movement plan decided in step S306 may include the timing at which the vehicle 30 starts moving toward the destination. In this case, for example, it is assumed that the vehicle 30 stands by in a parking lot near the entrance until the user 40 reaches a point where the distance from the exit is within a predetermined value.

Also, the movement plan decided in step S306 may include the moving speed of the vehicle 30. Here, the moving speed of the vehicle 30 may be changed by changing the target vehicle speed of the vehicle 30, or the moving speed of the vehicle 30 may be changed by changing the route to the destination. For example, the moving speed of the vehicle 30 to the destination may be set to be decreased by setting the route to the destination to a route that detours as compared to the usual route.

### 6. Outline

As described above, with the vehicle management system 100 according to the present embodiment, when the user 40 visits the area AR in which the location of the entrance and the location of the exit differ from each other by vehicle 30, the destination of the vehicle 30 is set so that the vehicle 30 moves to the exit. As a result, it is possible to reduce the time and effort needed for the user 40 to return to the entrance to collect the vehicle 30, thereby improving convenience for the user 40.

What is claimed is:

1. A vehicle management system for managing a vehicle, the vehicle management system comprising:
one or more storage devices that store entrance and exit information indicating a correspondence relationship between a location of an entrance and a location of an exit for each area; and
one or more processors, wherein the processors
determine whether an alighting position at which a user of the vehicle gets off the vehicle is the location of the entrance, based on the entrance and exit information, and
set a destination of the vehicle such that the vehicle moves to the location of the exit corresponding to the entrance, when the alighting position is the location of the entrance.

2. The vehicle management system according to claim 1, wherein:
the vehicle is an autonomous driving vehicle; and
the processors control the vehicle such that the vehicle moves to the set destination.

3. The vehicle management system according to claim 2, wherein the processors
cause a display device that displays information to the user to display a message requesting approval for setting the destination, and
control the vehicle such that the vehicle moves to the set destination in response to the user inputting information indicating approval to the display device.

4. The vehicle management system according to claim 2, wherein the processors
acquire position information of the user, and
decide a movement plan for moving the vehicle to the destination in accordance with the position information.

5. The vehicle management system according to claim 4, wherein the movement plan includes at least one of timing at which the vehicle starts moving to the destination, moving speed of the vehicle, and a target arrival time of the vehicle at the destination.

6. A vehicle that is able to be driven autonomously, the vehicle comprising:
one or more storage devices that store entrance and exit information indicating a correspondence relationship between one or more locations of entrances and a location of an exit for each area; and
one or more processors, wherein the processors
determine whether an alighting position at which a user of the vehicle gets off the vehicle is a location of an entrance, based on the entrance and exit information, and
set a destination of the vehicle such that the vehicle moves to the location of the exit corresponding to the entrance, when the alighting position is the location of the entrance.

7. A non-transitory storage medium storing a vehicle management program for managing a vehicle, the vehicle management program causing a computer to execute:
acquiring entrance and exit information indicating a correspondence relationship between one or more locations of entrances and a location of an exit for each area;
determining whether an alighting position at which a user of the vehicle gets off the vehicle is a location of an entrance, based on the entrance and exit information; and
setting a destination of the vehicle such that the vehicle moves to the location of the exit corresponding to the entrance, when the alighting position is the location of the entrance.
